(19) United States
(12) Patent Application Publication
(10) Pub. No.: US 2010/0264848 A1
(43) Pub. Date: Oct. 21, 2010

(54) METHOD OF SHUTTING DOWN A HIGH PRESSURE DISCHARGE LAMP AND DRIVING UNIT FOR DRIVING A HIGH PRESSURE DISCHARGE LAMP

(75) Inventors: Carsten Deppe, Aachen (DE); Holger Moench, Aachen (DE); Jens Pollmann-Retsch, Aachen (DE); Tom Munters, Aachen (DE); John-John Pieter Jan Van Den Bergh, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/993,075

(22) PCT Filed: Jun. 19, 2006
(86) PCT No.: PCT/IB2006/051952

§ 371 Date: Jun. 24, 2010

(30) Foreign Application Priority Data
Jun. 24, 2005 (EP) 05105674.5

(51) Int. Cl. H05B 41/36

(52) U.S. Cl. 315/307

(57) ABSTRACT

The invention describes a method of shutting down a high pressure discharge lamp (1) in which a pair of electrodes (2) are disposed in an arc tube (3). This method comprises the steps of reducing the lamp power (PA) to a reduced operation level that enables the maintenance of an arc discharge between the electrodes (2) in a transition state from a lighting state to an extinguished state; driving the lamp (1) at the reduced operation level such that that the lamp (1) cools down; monitoring the lamp voltage (U) during this lamp power reduction process and during driving of the lamp (1) at the reduced operation level with regard to a defined discharge process stability criteria and increasing the lamp power (PA) if the discharge process stability criterion is not satisfied; completely shutting down the lamp power (PA) after sufficient duration to allow the lamp (1) to cool down to a state in which the gas pressure is such that the lamp (1) could be reignited shortly after being extinguished. Moreover the invention describes an appropriate driving unit (7) for driving a high pressure discharge lamp (1) and an image rendering system (40), particularly a projector system, comprising such a driving unit (4).

This invention relates to a method of shutting down a high pressure discharge lamp, particularly a mercury vapour discharge lamp. Furthermore, the invention relates to a driving unit for driving a high pressure discharge lamp. Moreover, the invention relates to an image rendering system, particularly a projector system, comprising a high pressure discharge lamp and such a driving unit.

High pressure discharge lamps, for example mercury vapour discharge lamps comprise an envelope which consists of material capable of withstanding high temperatures, for example, quartz glass. From opposite sides, electrodes made of tungsten protrude into this envelope. The envelope, also called “arc tube” in the following, contains a filling consisting of one or more rare gases, and, in the case of a mercury vapour discharge lamp, mainly of mercury. By applying a high voltage across the electrodes, a light arc is generated between the tips of the electrodes, which can then be maintained at a lower voltage. Owing to their optical properties, high pressure discharge lamp, are preferably used, among others, for projection purposes. For such applications, a light source is required which is as point-shaped as possible. Furthermore, a luminous intensity—as high as possible—accompanied by a spectral composition of the light—as natural as possible—is desired. These properties can be optimally achieved with so called “high pressure gas discharge lamps” or “HID lamps” (High Intensity Discharge Lamps) and, in particular, “UHP—Lamps” (Ultra High Performance Lamps).

A number of different methods exist to ignite such lamps. Using the conventional method, a high voltage surges of more than 20 kV are applied to the electrodes. Some newer methods work with an ignition voltage of only 5 kV and an additional “antenna” which acts to reduce the necessary voltage.

All these methods have the problem that a user, after inadvertently extinguishing such a lamp, must wait quite a while—up to several minutes—before the lamp can be turned on again. This is because the lamp becomes very hot while turned on, and the pressure in the arc tube rises considerably. The higher the pressure in the arc tube, the greater the required ignition voltage. Therefore, the lamp must cool down after being extinguished until the pressure reaches a value at which the lamp can be ignited with the usual level of ignition voltage.

In an attempt to address this problem, JP 2004/319193 A describes a method in which the lamp of a projector system is first brought to a lower power level and then driven at this lower power level until the lamp has cooled down to such a point that it could be re-ignited relatively soon after being turned of During the transition phase in which the lamp is operating at the lower power level, the projector system ensures that the screen is brought to a state in which no image is projected. If, in this transition phase, the lamp is turned on again, the screen can be re-activated and the lamp power can quickly be increased. From the point of view of the user, it is as though the lamp is turned on again immediately. However, the rate at which the lamp can be re-ignited after being finally turned off depends on the power at which the lamp is driven in the transition phase, since, at a certain power, a certain temperature equilibrium and therefore a certain pressure equilibrium arises in the arc tube. Furthermore, as is the case for usual lamps—the re-ignition time depends on the level of the ignition voltage. In order to also be able to re-ignite the lamp with an ignition voltage as low as possible, it is advantageous to maintain the operation power at as low a level as possible in the transition phase. On the other hand, the lamp cannot be driven at just any indiscriminate low power level in the transition phase, but must be driven at a power level with a certain safety margin from the lowest possible level at which the discharge arc can be preserved. Otherwise, even minor deviations in current or voltage arising, for example, because of the physical processes taking place within the lamp, can lead to an inadvertent premature extinguishing of the lamp.

Therefore, an object of the present invention is to provide a method of shutting down a high pressure discharge lamp, whereby the lamp can be brought to a lowest possible temperature before being ultimately turned off.

To this end, the present invention provides a method of shutting down a high pressure discharge lamp, which method comprises the steps of reducing the lamp power to a reduced operation level that enables the maintenance of a discharge between the electrodes in a transition state from a lighting state to an extinguished state and driving of the lamp at the reduced operation level such that the lamp cools down. According to the invention, the lamp voltage is monitored during this lamp power reduction process and during driving of the lamp at the reduced operation level with regard to a defined discharge process stability criteria. The lamp power is briefly increased if the discharge process stability criterion is not satisfied. Finally, the lamp power is completely shut down after sufficient duration to allow the lamp to cool down to a state in which the gas pressure is such that the lamp could be reignited shortly—preferably immediately—after being extinguished, using its “normal” ignition circuit.

Using this method, the reduced operation level is essentially the lowest possible operation level at which an arc discharge may be maintained. Therefore, this method makes it possible to achieve a particularly low final temperature of the lamp, at which the lamp is extinguished, while ensuring that the lamp is not inadvertently extinguished too soon.

An appropriate driving unit for driving a high pressure discharge lamp should comprise a shut down request input for receiving an shut down request and a lamp power control unit which is configured in such a way that, upon receiving an shut down request, the lamp power is reduced to a reduced operation level enabling the maintenance of a discharge arc between the electrodes in a transition state from a lighting state to an extinguished state, and is driven at the reduced operation level such that that the lamp cools down. Furthermore, according to the invention, the driving unit must comprise a monitoring arrangement for monitoring the lamp voltage during the lamp power reduction process and during driving of the lamp at the reduced operation level with regard to a defined discharge process stability criteria. According to the invention, the driving unit should be configured in such a way that the lamp power is briefly increased if the discharge process stability criterion is not satisfied and the lamp power is completely shut down after sufficient duration to allow the lamp to cool down to a state in which the gas pressure is such that the lamp could be reignited shortly—preferably immediately—after being extinguished.

The dependent claims and the subsequent description disclose particularly advantageous embodiments and features of the invention.

A number of possibilities exist for defining a suitable stability criterion. However, to determine a stability criterion, a lamp voltage mean value is preferably always measured over a certain window, for example a certain time window, or a number of consecutive measurements (samples) of the lamp voltage are determined, and with the aid of the mean value, it can be determined whether individual voltage values deviate too strongly.

For example, the greatest measurement within a certain length of time can be determined, and the stability criterion is satisfied is this maximum value is less than the mean value multiplied by a certain factor. The factor depends to a large extent from the lamp and the exact driver circuitry. The value can be, for example, 1.25.

In a particularly preferred embodiment however, the lamp voltage mean value can be determined over a sliding window, and the stability criterion is satisfied as long as the difference between the current measured value and the mean value is less than a certain threshold value. The usual inaccuracy level of measurement and the usual rate of change of lamp voltage can be taken into consideration when determining this threshold level. Thus, a deviation of more than 1% can imply instability for a lamp with a particular driver circuit. For a different lamp and driver, a deviation of 10% can be acceptable.

Alternatively, other ways of carrying out the measurements are possible, e.g. a mean value can be computed for a fixed number of measurements, as well as the largest and smallest values, whereby the deviation of these two values from the mean value is to be assessed accordingly.

Instead of a sliding mean value, a mean value over all measurements over a lamp voltage period or half-period can be used. This is often done in order to suppress perturbations. In such a case, the level of inaccuracy drops, as does the effect of minor instabilities. Therefore, the threshold value can be chosen to be somewhat lower in such a case.

Regulation of the lamp power can be carried out, for example, by regulating the current lamp power directly towards a certain, very low, desired lamp power (desired value). In this case, for example, a certain power level is defined as desired lamp power, which certain power level lies below the level at which the discharge is maintained in a stable manner. Usually, a momentary power regulation is performed in the lamp drivers by regulating the current, i.e. a reduction or increase of the momentary power is obtained by reducing or increasing the current.

Preferably, at least during driving of the lamp at the reduced operation level, the desired lamp power (also called nominal power) is controlled by a target lamp power and the momentary desired lamp power is increased if the discharge process stability criterion is not satisfied and the actual lamp power (or actual current) is subsequently controlled by the momentary desired lamp power. This method, by which a nominal power is adapted gradually to the target power, and the momentary power in turn is regulated according to the desired power, has the advantage that the desired power—as a imaginary quantity—can be regulated according to the desired precepts, without requiring any intervention in the driver's nominal power regulation, used by the driver to regulate the nominal power in normal operation. The entire regulation cycle can then operate faster. In contrast to this, if the momentary power regulation were to be “misused” to regulate the power to a reduced power level, instead of being used for “normal” power regulation, the regulation cycle would be slowed down and the power regulation would not be able to react so quickly.

Reduction of power from the normal operating level to the reduced power level can be done in a number of ways. For example, according to a first method, the power can be reduced relatively slowly, continuously or step-wise. Another, preferred, method requires that the power be brought down to a certain first low power level, and from that level be slowly reduced, continually or step-wise, until the lowest level is reached at which the stability of the discharge is maintained. Thereby, the rate of change of reduction of power at which the desired lamp power is adjusted to the target lamp power can be chosen depending on the momentary lamp power. In other words, in the case of a relatively low momentary power, the power will only be reduced further at a slow rate, whereas for a higher momentary power, the changes take effect faster. In this method, the system feels its way towards the lowest possible power level in order to avoid an inadvertent premature extinguishing of the lamp.

In a preferred embodiment of the invention, a forced cooling of the lamp is initiated or increased at least during one stage of the shutting down process. For example, a cooling means, e.g. a ventilator or ventilator array, can be arranged in some way in the lamp, and this cooling means will be activated accordingly or the number of revolutions per minute will be increased or an auxiliary cooler will be turned on as soon as the command to shut down the lamp has been sent to the lamp driver and the lamp is to be cooled down.

Various possibilities also exist for determining the length of time elapsed until the lamp is sufficiently cooled down and can finally be turned off. For example, the lamp can be turned off after reaching the low equilibrium temperature.

This can be done, for example, by observing the rate at which the voltage drops. If no significant change in voltage is noticeable, it may be assumed that equilibrium has been reached.

In a particularly simple version, the lamp is shut down after being driven at the reduced operation level over a certain predefined time period. This time period is preferably at least ca. 60 sec.

In another preferred embodiment the gas pressure in the lamp is monitored during driving of the lamp at the reduced operation level and the lamp is shut down according to the observed gas pressure.

The lamp pressure can be estimated on the basis of the average lamp voltage, e.g. by measuring and noting the average lamp voltage in the preceding normal operation, and then checking to see whether the lamp voltage has dropped below a certain value, which value can be determined by multiplying the average voltage in normal operation by a certain factor. For example, the cool-down time can be deemed to be sufficient when the average lamp voltage at reduced power level is only half of the average lamp voltage in normal operation.

In a further preferred embodiment of the invention, the lamp voltage and the lamp current are monitored and analysed, and a property of a current-voltage characteristic of the lamp is determined to give an indication of the gas pressure in the arc tube. This method is particularly successful in the case of mercury vapour discharge lamps.

In the normal mode of operation, a mercury vapour discharge lamp displays negative current-voltage characteristics. A reduction of the lamp power, usually effected by reducing the current, causes an increase in operation voltage. However, it could be found that if some mercury has condensed, the voltage response to the variation in power (or current) is determined primarily by the variation in mercury pressure. This results in a different response of a lamp voltage to the reduction in current. Contrary to the case of an unsaturated lamp, the voltage of a saturated lamp drops due to mercury condensation and the resulting reduction in mercury pressure. Similar differences in voltage response behaviour are observed in the case of an increase in current. This behaviour can be explained as follows: if the current is reduced during the unsaturated regime, i.e. in normal mode of operation, the plasma between the electrodes cools to a lower temperature and the degree of ionization drops. As a result, the resistance of the lamp increases, as does the operation voltage. In a state of saturation, on the other hand, increasing the current results in an increased heat output of the lamp. This leads at first to mercury evaporation from the molten mass. The increase in evaporated mercury atoms in the gas also results in an increase of the resistance of the lamp. This effect plays a dominant role and leads to the increase in voltage if the current is increased for a saturated lamp.

This observation regarding the behaviour of the voltage as a function of the level of current is put to use in order to determine, in an easy and uncomplicated manner, an indication of the state of mercury saturation in the bulb by simultaneously measuring the voltage and the current as well as the relationship of these measurements to one another.

In a further embodiment of the invention, the ratio of the slope of the lamp voltage to the slope of the lamp current is used to give a quantitative indication regarding the state of mercury saturation in the lamp.

An image rendering system according to the invention, in particular a projection system, must, according to the invention, comprise, besides a high pressure discharge lamp, a driving unit pursuant to the invention for the lamp. Particularly preferably, such an image rendering system should also comprise a central control unit, in order to send a shut down request to the driving unit and/or, for example, to control a cooling means in order to start a forced cooling of the lamp or to increase the forced cooling, at least in a certain stadium of the shut down process.

Use of such a higher-ranking control unit has the advantage that a typical lamp driver need only be slightly modified, for example by corresponding software updates in a programmable control chip of the lamp driver which controls the power. Complicated hardware modifications to the lamp driver would not be necessary.

Most projector systems have, in any case, a central control unit which control and synchronize the further components of the projector system, such as, for example, a colour wheel or a display. In such a case, the central control can be used to issue an appropriate command for the display, simultaneously with the shut down request for the lamp driver, in order to cause the display to be darkened, i.e. further image rendering is avoided as long as the lamp is in the transition phase between receiving the shut down request and complete extinguishing of the lamp. This process effectively goes unnoticed by the user. He will only be aware of the fact that the projector can be turned on again immediately after an inadvertent turning off, since the lamp is either still in the transition state and can therefore be brought back to a normal operating power level, or if the lamp has indeed been extinguished completely, it will have cooled down sufficiently due to the method according to the invention, so that it can be re-ignited immediately.

Generally the invention might be used for all types of high pressure discharge lamps. Preferably it is used for HID lamps and particularly UHP lamps. The invention can also be applied to other lamps which are not intended for use in projection systems, for example, lamps for automotive lightning systems.

Other objects and features of the present invention will become apparent from the following detailed descriptions considered in conjunction with the accompanying drawings. It is to be understood, however, that the drawings are designed solely for the purposes of illustration and not as a definition of the limits of the invention. In the drawings, wherein like reference characters denote the same elements throughout:

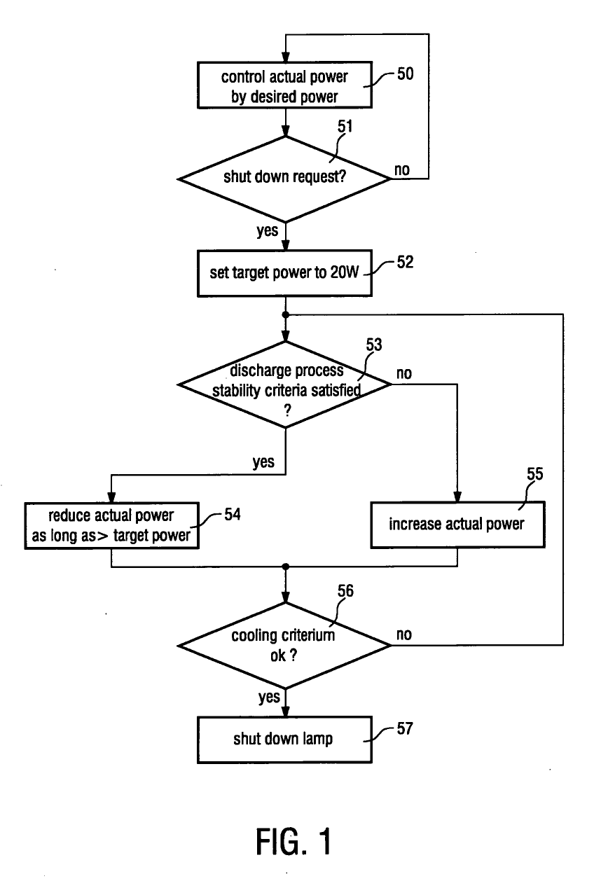

FIG. 1 shows a flow chart of a possible sequence of actions of the method pursuant to the invention according to a first embodiment;

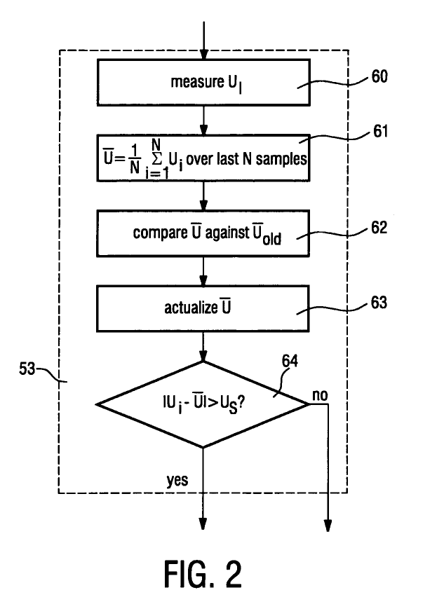

FIG. 2 shows a flow chart of a possible monitoring process to monitor the discharge process stability criteria;

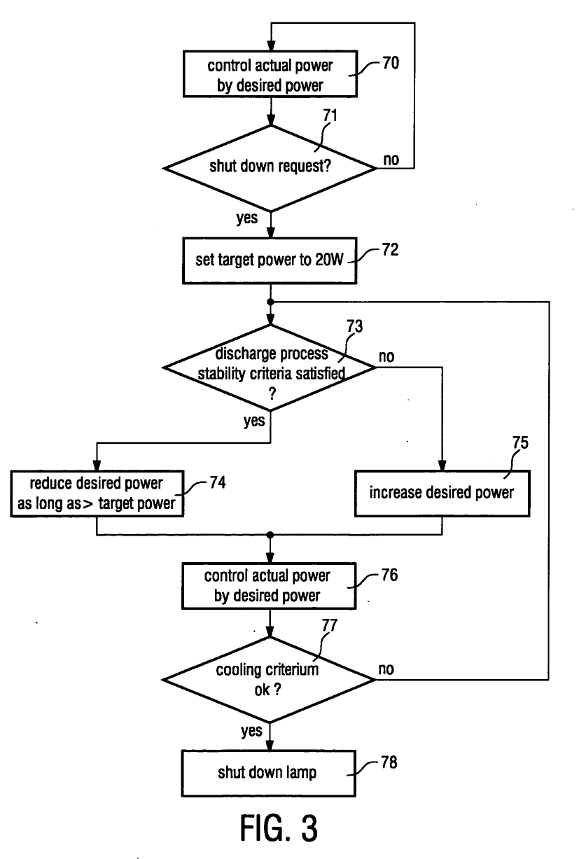

FIG. 3 shows a flow chart of a possible sequence of actions of the method pursuant to the invention according to a second embodiment;

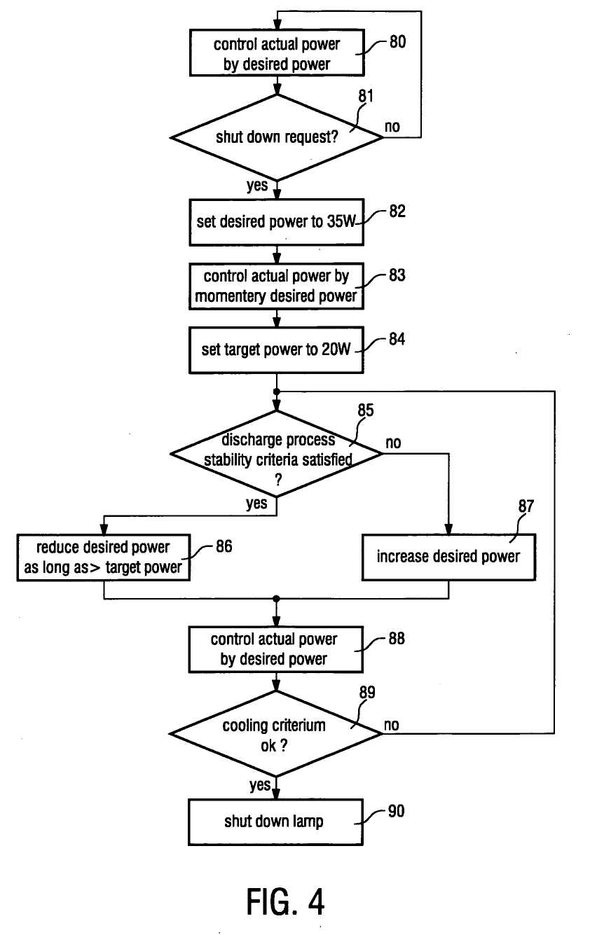

FIG. 4 shows a possible sequence of actions of the method pursuant to the invention according to a third embodiment;

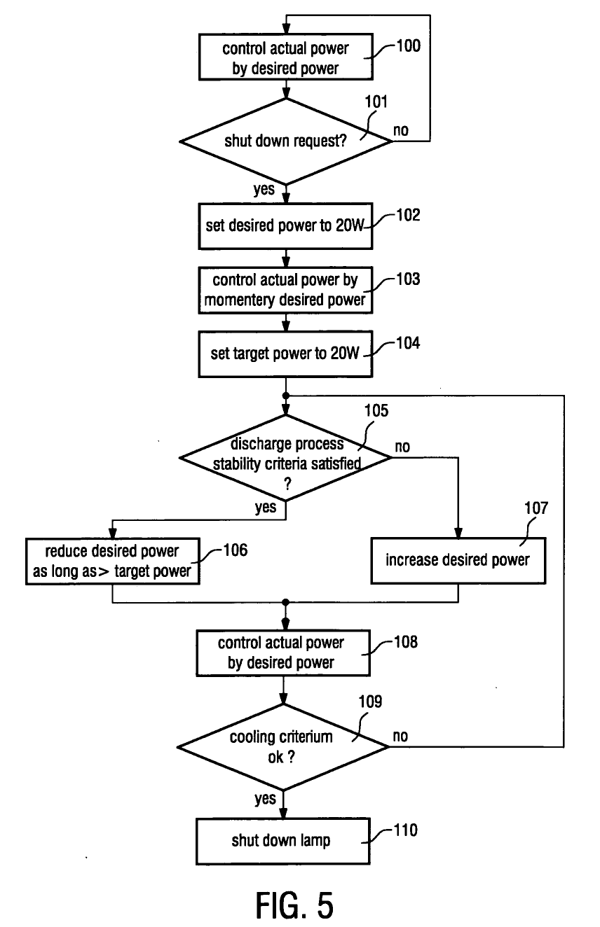

FIG. 5 shows a possible sequence of actions of the method pursuant to the invention according to a fourth embodiment;

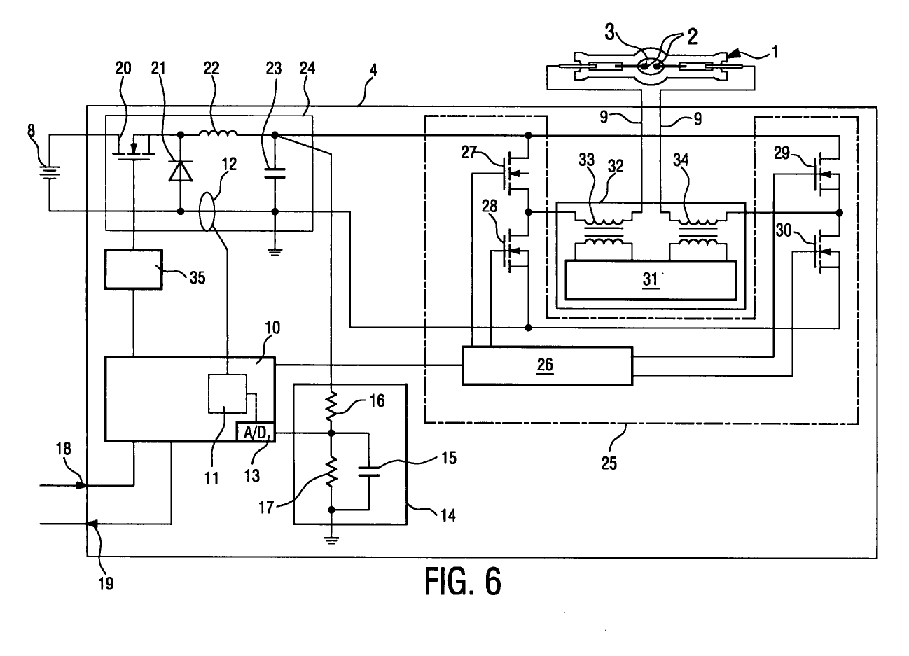

FIG. 6 shows a block diagram of a lamp driving unit according to the invention;

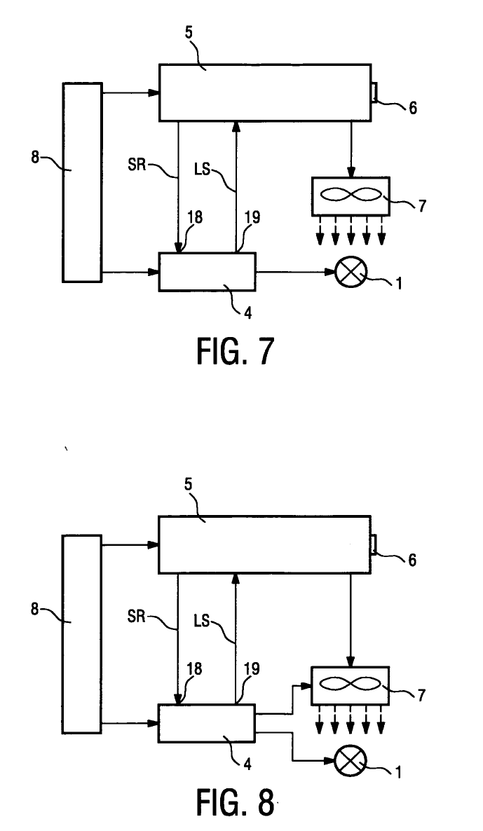

FIG. 7 shows a schematic diagram of a lamp, a cooling means and the required control components of a projector system according to a first embodiment;

FIG. 8 shows a schematic diagram of a lamp, a cooling means and the required control components of a projector system according to a second embodiment;

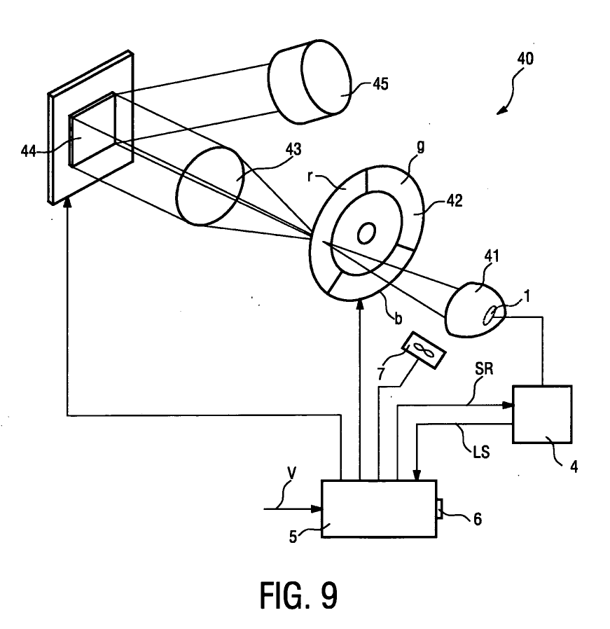

FIG. 9 shows a schematic representation of an embodiment of a projector system according to the invention;

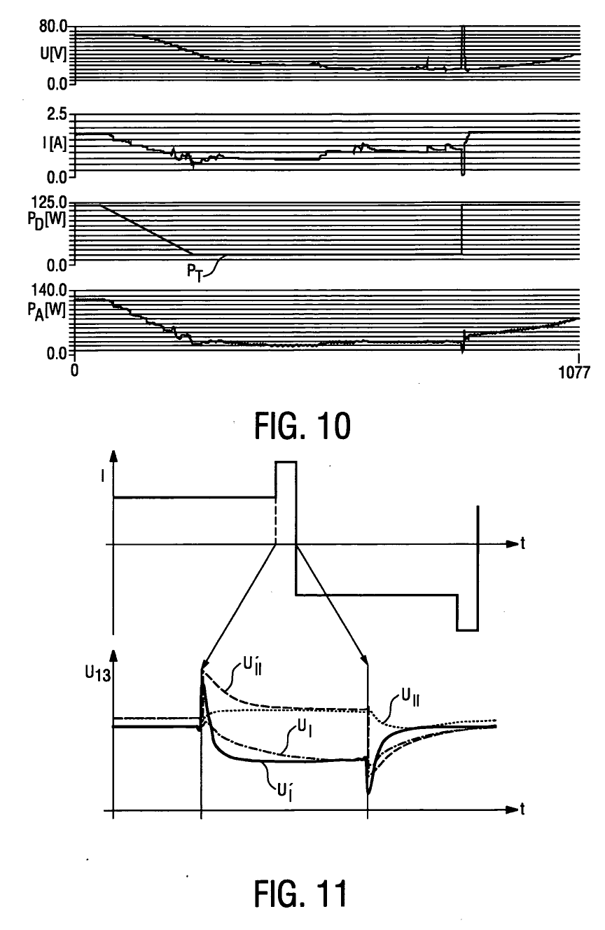

FIG. 10 shows the progression of lamp voltage, lamp current, a nominal lamp power and a momentary lamp power in a reduction of the lamp power to a lowest power level at which the discharge can just be maintained, as well as a subsequent return in lamp power to normal operating power;

FIG. 11 shows the voltage changes of a 120 Watt UHP lamp during variation of the lamp power.

The dimensions of the objects in the figures have been chosen for the sake of clarity and do not necessarily reflect the actual relative dimensions.

In FIGS. 1-5, possible sequences of actions for turning off a mercury vapour discharge lamp are described. It goes without saying that the values mentioned in connection with these definite courses of action are purely exemplary and relate—without restricting the generality of the invention—to a mercury vapour discharge lamp with 120/130 Watt nominal power in normal operation of the lamp. Evidently, these values must be adjusted to suit any lamps or driver constructions actually used.

In the sequence of actions shown in FIG. 1, the momentary lamp power is directly influenced in the shut down process. The initial steps 50,51 of this flow-chart show that the momentary power is regulated in the usual way, for example to the normal nominal value for the operation of the lamp. Step 51 continually checks, in a loop, whether a shut down request has been registered, i.e. whether the user wishes to turn off the lamp. If this is the case, the method of actually shutting down the lamp commences in step 52. To this end, a “target power” is first reduced to 20 W in step 52. The power level of 20 W lies below the level at which the lamp can operate in a stable manner. The target power should preferably lie in the range of 20 to 25% of the nominal power, and particularly preferably below this.

Subsequently, a regulation loop comprising steps 53, 54, 55 and 56 commences, whereby in the first step 53, the discharge process stability criterion is assessed. A possibility for this assessment is explained in more detail in the following with the aid of FIG. 2. If the discharge process stability criterion is satisfied, the momentary power will be reduced, by reducing the momentary current, until the desired target power of 20 W is attained (step 54). If, on the other hand, the discharge process stability criterion is not satisfied, the actual power is briefly raised in step 55.

Subsequently, in both cases, step 56 assesses whether the lamp is sufficiently cooled or not. As mentioned previously, this might merely involve checking if a certain time period has elapsed, i.e. if a certain cool-down period has elapsed. Equally, a criterion pertaining to the momentary or mean voltage of the lamp can be assessed. Further possibilities are measuring the temperature or estimating the pressure in the lamp, which will be explained in more detail later with the aid of FIG. 11.

If the cool down criterion has not been reached in step 56, step 53 assesses the discharge process stability criterion again, and further reduces the momentary power accordingly, or—if the discharge process stability criterion has not been fulfilled, raises the power again in step 55. This method ensures that the momentary lamp power is permanently held art the lowest possible level at which the discharge arc can be maintained, until the cool down criteria can be satisfied. Once step 56 determines that the cool down criteria have been satisfied, the final shut-down of the lamp can follow in step 57.

FIG. 2 shows a possible flow chart for assessing the discharge process stability criteria. The entire course of action shown in FIG. 2 can take the place of step 53 in the flow chart of FIG. 1.

Assessment commences in step 60 by measuring a lamp voltage sample Uᵢ. This measurement is carried out at regular intervals. For example, in driver circuits currently in use, sixteen measurements are made at short intervals within a half period of the lamp. Then, in step 61, a lamp power mean value Ū is calculated as the mean value of the previous N samples. Subsequently, in step 62, the new mean value Ū is compared with a mean value Ū_{old} computed for the previous measurements, and, in step 63, an update of the mean value can take place, or the old mean value Ū_{old} is replaced by the new mean value Ū for a comparison in the following measurement cycle.

Instead of storing the previous N measurements and computing a corresponding mean value, comparing this with the old mean value and, if applicable, to update it in step 61, a sliding mean value Ū can continually be computed with a new measurement value Uᵢ, for example according to the following equation:

Ū=Ū_{old}·0.95+Uᵢ·0.05

This corresponds to a first-order low-pass filter and may also be realized using a discrete analogue circuit.

Regardless of the manner in which the current mean value Ū is computed, step 64 can assess the actual stability criteria, by assessing whether a discrepancy of the current measurement value Uᵢ from the mean value Ū is greater than (or has reached) a certain threshold value Uₛ. This threshold value can be defined to be a percentage of the mean value Ū. For example, depending on the lamp and the driver circuit implemented, it may lie between 1% and 10% of the mean Ū.

FIG. 3 shows a method according to the invention, similar to that of FIG. 1, for switching off a lamp. Here also, in step 70, the “normal” power regulation is carried out during operation of the lamp, and step 71 checks within a loop whether a shut down request has been registered. Also, if this is the case, step 72 first specifies a target power of 20 W.

The regulation cycle then commences, which also starts with assessment of the stability criterion in step 73. However, unlike the method of FIG. 1, no direct intervention in the power regulation takes place. Instead, the desired power for the regulation cycle, which regulates the momentary power according to a desired lamp power, is either reduced in step 74, insofar as the discharge process stability criterion is satisfied and as long as the target power is greater than the target power, or the desired power is raised in step 74. In step 76, the actual or momentary power is regulated according to the momentary desired power. Regulation of the actual power according to the predefined desired power is effected in the usual manner by regulating the current.

Also in the method according to FIG. 1, it is subsequently assessed in step 77 whether the cooling criterion is satisfied, the loop is completed again, and, insofar as the cooling criterion is satisfied, the lamp is finally extinguished in step 78.

The advantage of the sequence of actions described in FIG. 3 is that the imaginary desired power value is reduced towards the target power according to requirements, without actually intervening in the usual actual power regulation of the driver, and the latter is not unnecessarily inhibited in any way as a result.

During the method according to FIGS. 1 and 3, the power is slowly adjusted to the target power. This is particularly desirable when the power regulation tends to result in oscillations. Thus, in small increments, the actual power approaches the target power in step 54 of FIG. 1, or the desired power approaches the target power in step 74 of FIG. 3 (whereby the actual power is regulated according to the momentary desired power in step 76). The size of the incremental steps can be defined in accordance with the lamp and the driver construction. For example, the desired power of a lamp with a nominal power of 120 W can be reduced by 0.067 W in each lamp period. At a lamp frequency of 50 Hz, this would allow a target power of 20 W to be reached within 30 seconds. If an instability is detected in steps 53 or 73, the momentary power or the desired power can be raised, in steps 55 and 75 respectively, by, for example, 5 W. A return to the target power can then take place at 0.067 W per period.

In this method, it can be desirable to adapt the rate of change to the momentary power. Thus, for a large discrepancy between the desired power and the target power, the desired power can be reduced by 0.1 W per period, and for discrepancies less than, for example, 5 W, the desired power can be reduced by only 0.01 W per period.

In order to accelerate the process, the desired power can be reduced, in an initial first stage, to a lower power, as long as it is certain that this will not cause the discharge arc to be extinguished. This version of the method is illustrated in FIG. 4. Here also, step 80 represents the usual power regulation of the lamp, and the continual polling of a shut down request is carried out in step 81. If such a shut down request is registered, the desired power is immediately reduced to 35 W in step 82. The actual power is subsequently regulated according to the momentary desired power in step 83. Thereafter, setting the target power to 20 W can take place in step 84, corresponding to steps 52 and 72 of FIGS. 1 and 3. Further regulation of the desired power to the specified target power can then take place in the regulation cycle with steps 85, 86, 87, 88, 89, corresponding to the regulation cycle of FIG. 3 with steps 73, 74, 75, 76, 77. Then, if the cooling criterion has been assessed in step 89 and is satisfied, the lamp can finally be extinguished in step 90.

This particularly preferred two-stage process ensures an initial rapid reduction in power to a safe value above the target power, and a subsequent slow and careful approach to the actual target value.

FIG. 5 shows a further alternative process in which, after a shut down request has been registered in step 101 during the usual power regulation in step 100, the desired power is immediately reduced to 20 W in step 102, and then, in step 103, the actual power is regulated to approach this desired power. Immediately, the target power is reduced to 20 W in step 104 (shown here as a following step for the sake of clarity), and assessment of the discharge process stability criterion is carried out in step 105, in order to make sure than the lamp is not extinguished. The following loop for regular assessment of the discharge process stability criterion and corresponding raising of the desired power in step 107, or reduction of the desired power in step 106, and also the regulation of the actual power to the momentary desired power in step 108 and assessment of the cooling criterion in step 109 correspond to the usual method as already described with the aid of FIGS. 3 and 4. In this case also, as soon as the cooling criterion is satisfied in step 109, the lamp can finally be extinguished in step 110.

The assessment of the discharge process stability criterion in step 73 of FIG. 3, step 85 of FIG. 4 or step 105 of FIG. 5 can, besides, also be effected in the same way as already described for step 53 of FIG. 1 or with FIG. 2.

As already mentioned above, a value of time can simply be taken for the cooling criterion, i.e. it can be estimated after which length of time the lamp is probably sufficiently cooled down, by, for example, having reached the equilibrium temperature, and after this length of time has elapsed, the process can be interrupted and the lamp finally turned off. In experiments carried out for a 120 W mercury lamp, it has been observed that, when the lamp is regulated down to a target power of ca. 20 W, a cool-down period of 60 s-240 s is sufficient. This length of time can be decreased proportionally to a cooling of the lamp, e.g. by external air cooling.

Evidently, it is better if the pressure in the lamp is estimated more precisely, so that the lamp can then accordingly be finally turned off when the pressure has dropped below a certain level. This has the advantage that, on the one hand, the lamp will not be turned off too soon in the case where unfavourable conditions result in a slower cooling down of the lamp, and, on the other hand, in situations where the lamp does actually cool down quite rapidly, the process does not take unnecessarily long.

One possibility of estimating the momentary pressure in the lamp involves observing the relationship between the current and voltage, or between the slopes of the current and voltage.

FIG. 11 shows an example of current I (upper) and voltage U₁₃ (lower) curves recorded over one lamp current cycle. The current I shows an additional increase before each commutation, the so-called anti-flutter pulse, which is applied in most lamps for stability reasons. The voltage U₁₃ shown is the voltage measured at the input of the A/D converter 13 in FIG. 6. The dotted and dot-dashed curves U_{I}, U_{II} show the measurement with a comparably large capacitor 15, the dashed and solid curves solid curves U_{I′},U′_{II} show the measurement with a very small capacitor 15, or no capacitor at all.

The first pair of curves U_{I}, U′_{I} shows the typical voltage response measured under normal operation conditions with a mercury pressure of about 200 bar. The second pair of curves U_{II}, U′_{II} shows the same measurement at reduced pressure, for example 50 bar.

Evidently, with this voltage response, the pressure inside the lamp 1 can be determined from voltage measurement. A sharp negative change in voltage when applying the increased current indicates high pressure, while a more flattened change indicates condensation of mercury and thus reduced pressure. Finally this change tends to become positive, i.e. instead of a drop in voltage, an increase can be observed.

The driver control can therefore set a certain threshold for this voltage change, in order to determine the time at which the lamp pressure has gone low enough to switch the lamp off.

Even more advanced solutions can also measure the transition time of the voltage step response, which, as can be seen, also indicates a strong change with lamp pressure.

FIG. 6 shows a possible realisation of a driving unit 4 according to the invention for driving a gas discharge lamp.

This driving unit 4 is connected via connectors 9 with the electrodes 2 in the discharge chamber 3 of the gas discharge lamp 1. Furthermore, the driving unit 4 is connected to a power supply 8, and features an input 18 to receive a shut down request or other control signals, and also an output 19, for reporting, for example, the lamp status LS to a higher-level control unit.

The driving unit 4 comprises a direct current converter 24, a commutation stage 25, an ignition arrangement 32, a lamp power control unit 10, a voltage measuring unit 14, and a current measuring unit 12.

The lamp power control unit 10 controls the converter 24, the commutation stage 25, and the ignition arrangement 32, and monitors the voltage behaviour of the lamp driver 4 at the gas discharge lamp 1.

The commutation stage 25 comprises a driver 26 which controls four switches 27, 28, 29, 30. The ignition arrangement 32 comprises an ignition controller 31 (comprising, for example, a capacitor, a resistor and a spark gap) and an ignition transformer which generates, with the aid of two chokes 33, 34, a symmetrical high voltage so that the lamp 1 can ignite.

The converter 24 is fed by the external direct current power supply 8 of, for example, 380V. The direct current converter 24 comprises a switch 20, a diode 21, an inductance 22 and a capacitor 23. The lamp power control unit 10 controls the switch 20 via a level converter 35, and thus also the current in the lamp 1. In this way, the actual lamp power is regulated by the lamp power control unit 10.

The voltage measuring unit 14 is connected in parallel to the capacitor 23, and is realised in the form of a voltage divider with two resistors 16, 17. A capacitor 15 is connected in parallel to the resistor 17.

For voltage measurement, a reduced voltage is diverted at the capacitor 23 via the voltage divider 16, 17, and measured in the lamp power control unit 10 by means of an analogue/digital converter 13. The capacitor 15 serves to reduce high-frequency distortion in the measurement signal.

The current in the lamp 1 is monitored in the lamp power control unit 10 by means of the current measuring unit 12, which also operates on the principle of induction. Since the lamp power control unit 10 controls the current in the lamp 1 by means of the level converter 35 and the switch 20, the momentary current level can also be taken over in the lamp power control unit 10. In this case, the current measuring unit required according to the invention is directly integrated in the control circuit, and the external current measuring unit 36 shown in FIG. 6 can, for example, be used for checking purposes, or, for some types of lamps, be dispensed with entirely.

The lamp power control unit 10 comprises a programmable microprocessor. An analysing unit 11 is implemented here in the form of software running on the microprocessor of the control circuit. The analysing unit 11 records and analyses the measurement values reported by the voltage measuring unit 14 and the current measuring unit 12.

Together with the voltage measuring unit 14 and the analogue/digital converter 13, the analysing unit 11 offers a monitoring arrangement for monitoring the lamp voltage during the lamp power reduction process, and during driving of the lamp at the reduced operation level. The analysis or assessment within the analysing unit 11 can be carried out with regard to the defined discharge process stability criterion according to the invention, so that the lamp power control unit 10 can regulate the process described under FIGS. 1 and 4.

A monitoring of the pressure, as described under FIG. 5, can also be carried out in the analysing unit 11, since the voltage is monitored here, and the current can also be measured with the aid of the current measuring unit 12. Therefore, using the analysing unit 11, the cooling criterion can also be assessed, and the shut down process can be ended by finally turning off the lamp 1.

The command to initiate the shut down process of the lamp is forwarded to the lamp control unit 10 directly via the input 18 in the form of a shut down request. The momentary lamp status LS of the lamp 1 can be made known by the lamp power control unit 10 via the output 19.

In particular, the lamp status LS can report whether the lamp 1 is still being driven towards the reduced power level in the transition period, or whether the shut down process is complete. If necessary, other more precise information, e.g. pertaining to the momentary pressure and determined by the analysing unit 11, can be made known via this output 19.

FIGS. 7 and 8 show possible realisations in which the lamp driving unit 4 can be driven by a central control unit 5 in an image rendering system 40. In the following it is assumed that the image rendering system 40 is a projector system whose basic construction is shown in FIG. 9.

The projector system shown in FIG. 9 is a sequential system, in which the different colours—red, green and blue—are rendered one after the other, whereby distinct colour s are perceived by the user owing to the reaction time of the eye.

Thereby, the light of the lamp 1 is focussed within a reflector 41 onto a colour wheel 42 with three colour regions red R, green G, and blue B. This colour wheel is driven at a certain pace, so that either a red image, a green image, or a blue image is generated. The red, green, or blue light generated according to the position of the colour wheel 42 is then focussed by a collimating lens 43, so that a display unit 44 is evenly illuminated. Here, the display unit 44 is a chip upon which is arranged a number of miniscule moveable mirrors as individual display elements, each of which is associated with an image pixel. The mirrors are illuminated by the light. Each mirror is tilted according to whether the image pixel on the projection area, i.e. the resulting image, is to be bright or dark, so that the light is reflected through a projector lens 45 to the projection area, or away from the projector lens and into an absorber. The individual mirrors of the mirror array form a grid with which any image can be generated and with which, for example, video images can be rendered. Rendering of the different brightness levels in the image is effected with the aid of a pulse-width modulation method, in which each display element of the display apparatus is controlled such that light impinges on the corresponding pixel area of the projection area for a certain part of the image duration, and does not impinge on the projection area for the remaining time.

An example of such a projector system is the DLP®-System (DLP=Digital Light Processing) of Texas Instruments®.

Naturally, the invention is not limited to that kind of projector system, but can be used with any other kind of projector system.

FIG. 9 also shows that the lamp 1 is controlled by a lamp driving unit 4, which is in turn controlled by a central control unit 5. Here, the central control unit 5 also controls a ventilator 7 for cooling the lamp 1, and also manages the synchronisation of the colour wheel 42 and the display apparatus 44. A signal such as a video signal V can be input to the central control unit 5 as shown in this diagram.

As is also shown in FIG. 7, this central control unit 5 is also connected to the power supply 8, and is provided with a user interface 6, for example an on/off switch or remote control input or similar, with which the user can turn off the projector system 40. The control unit subsequently sends a shut down request SR to the input of the lamp driver 4, so that this can reduce the lamp power in the prescribed way, and then turn off the lamp 1 after is has cooled down sufficiently. Simultaneously, the central control unit 5 activates the ventilator 7, or increases the ventilation to a maximum, in order to accelerate the cooling of the lamp 1. Furthermore, the central control unit 5 can control the display unit 44 so that an image is no longer rendered, so that from the point of view of the user, the device is indeed turned off, and light is no longer projected on to the projection area.

As soon as the lamp driving unit 4 has completely turned off the lamp 1, it reports a corresponding lamp status signal LS via the output 19 to the central control unit 5, which then turns off the ventilator 7 and the lamp driving unit 4, and, for example, places the entire apparatus in a stand-by state, or turns it off completely via a switch of the power supply 8.

FIG. 8 shows a somewhat different realisation. The difference between this realisation and that of FIG. 8 is basically that the ventilator 7 is not controlled by the central control unit 5 in this case, but is directly controlled by the lamp driving unit 4.

FIG. 10 shows, from top to bottom, the average lamp voltage U, lamp current I, desired power P_{D} and actual power P_{A} curves for a lamp which is being driven over a longer period of time towards a lower power level. The actual or momentary power of the lamp P_{A} follows the lamp current I. The desired power P_{D} is reduced to a specified target power P_{T} of 20 W and held at that level. The actual power follows this precept unevenly due to the stability criterion assessment. This is a simple power regulation as described above under FIG. 1.

It can be clearly seen that the power does indeed first drop to 20 W towards the middle of the graph. Thereafter, one can see a small spike, also visible in the curve for average lamp voltage U. At the same time, one can see that the lamp current I is raised in relatively large increments. Due to this repeated increase, the actual lamp power P_{A} ultimately approaches 30 W. This is the applicable power value, for the lamp used in this experiment, at which the discharge arc can just be maintained. Towards the end of the experiment, the desired power is shut down and immediately turned on again. The actual lamp power P_{A} slowly returns to the nominal value.

Although the present invention has been disclosed in the form of preferred embodiments and variations thereon, it will be understood that numerous additional modifications and variations could be made thereto without departing from the scope of the invention. For the sake of clarity, it is also to be understood that the use of “a” or “an” throughout this application does not exclude a plurality, and “comprising” does not exclude other steps or elements. Also, a “unit” may comprise a number of blocks or devices, unless explicitly described as a single entity.

1. A method of shutting down a high pressure discharge lamp (1) in which a pair of electrodes (2) is disposed in an arc tube (3), which method comprises the steps of
reducing the lamp power (P_{A}) to a reduced operation level that enables the maintenance of an arc discharge between the electrodes (2) in a transition state from a lighting state to an extinguished state;
driving the lamp (1) at the reduced operation level such that that the lamp (1) cools down;
monitoring the lamp voltage (U) during this lamp power reduction process and during driving of the lamp (1) at the reduced operation level with regard to a defined discharge process stability criteria and increasing the lamp power (P_{A}) if the discharge process stability criteria is not satisfied;
completely shutting down the lamp power (P_{A}) after sufficient duration to allow the lamp (1) to cool down to a state in which the gas pressure is such that the lamp (1) could be reignited shortly after being extinguished.

2. The method according to claim 1, wherein
for determination of the discharge process stability criteria a lamp voltage mean value (Ū) over a certain window is determined.

3. The method according to claim 2, wherein
a lamp voltage mean value (Ū) over a sliding window is determined
and the discharge process stability criteria is satisfied as long as the distance of a momentarily measured voltage value (Uᵢ) to the lamp voltage mean value (Ū) is below or equal a threshold value.

4. The method according to any of claims 1 to 3, wherein,
at least during driving of the lamp (1) at the reduced operation level, a desired lamp power (P_{D}) is controlled by a target lamp power (P_{T})
and the momentary desired lamp power (P_{D}) is increased if the discharge process stability criteria is not satisfied
and the actual lamp power (P_{A}) is subsequently controlled by the momentary desired lamp power (P_{D}).

5. The method according to any of claims 1 to 4, wherein,
during the lamp power reduction process, the rate of reduction of power is chosen according to the momentary lamp power (P_{A}).

6. The method according to any of claims 1 to 5, wherein
in a first phase of the lamp power reduction process the lamp power (P_{A}) is fast reduced to a defined first power level.

7. The method according to any of claims 1 to 6, wherein
a forced cooling of the lamp (1) is initiated or increased at least during one stage of the shutting down process.

8. The method according to any of claims 1 to 7, wherein
the lamp (1) is shut down after being driven at the reduced operation level over a certain predefined time period.

9. The method according to any of claims 1 to 7, wherein the gas pressure in the arc tube (3) of the lamp (1) is monitored during driving of the lamp (1) at the reduced operation level and the lamp (1) is shut down according to the observed gas pressure.

10. The method according to claim 9, wherein
the lamp voltage (U) and the lamp current (I) are monitored and analysed, and a property of a current-voltage characteristic of the lamp (1) is determined to give an indication of the gas pressure in the arc tube (3).

11. A driving unit (7) for driving a high pressure discharge lamp (1) in which a pair of electrodes (2) is disposed in an arc tube (3), which driving unit (7) comprises
a shut down request input (18) for receiving a shut down request (SR);
a lamp power control unit (10) which is configured in such a way that upon receiving a shut down request (SR) the lamp power (P_{A}) is reduced to a reduced operation level that enables the maintenance of an arc discharge between the electrodes (2) in a transition state from a lighting state to an extinguished state and that the lamp (1) is driven at the reduced operation level such that that the lamp (1) cools down;
and a monitoring arrangement (11, 13, 14) for monitoring the lamp voltage (U) during the lamp power reduction process and during driving of the lamp (1) at the reduced operation level with regard to a defined discharge process stability criteria;
whereby the lamp power control unit (10) is configured in such a way that the lamp power (P_{A}) is increased if the discharge process stability criteria is not satisfied and the lamp power (P_{A}) is completely shut down after sufficient duration to allow the lamp (1) to cool down to a state in which the gas pressure is such that the lamp (1) could be reignited shortly after being extinguished.

12. An image rendering system (40), particularly a projector system, comprising a high pressure discharge lamp (1) in which a pair of electrodes (2) are disposed in an arc tube (3), and comprising a driving unit (4) according to claim 10.

13. An image rendering system (40) according to claim 11, comprising
a central control unit (5) for sending a shut down (SR) request to the driving unit and for controlling a cooling arrangement (8) in order to initiate or increase a forced cooling of the lamp at least during one stage of the shutting down process.
